(19) United States
(12) Patent Application Publication
(10) Pub. No.: US 2017/0019499 A1
(43) Pub. Date: Jan. 19, 2017

(54) ADAPTIVE COMPONENT BASED APPLICATION

(71) Applicant: SugarCRM Inc., Cupertino, CA (US)

(72) Inventors: Robert Gonzalez, Fremont, CA (US); Andrew Lee, San Jose, CA (US); Adam Voigt, Asheboro, CA (US)

(21) Appl. No.: 14/802,775

(22) Filed: Jul. 17, 2015

(51) Int. Cl. H04L 29/08

(52) U.S. Cl. CPC H04L 67/327; H04L 67/22

(57) ABSTRACT

Embodiments of the present invention provide a method, system and computer program product for the adaptive customization of application components, such as different application modules or data objects. In an embodiment of the invention, an adaptive customization of application component method includes executing an application in memory of a computer and monitoring by the application interactions between an end user and the application. The method also includes computing by the application a frequency of access of components of the application. Finally, the method includes re-starting execution of the application including only components computed to be most frequently accessed while excluding components computed to be less frequently accessed.

### BACKGROUND OF THE INVENTION

Field of the Invention

The present invention relates to component based application customization and more particularly to adapting a component based application in accordance with end user use patterns.

Description of the Related Art

Conventional application utilization has as its prerequisite the development and distribution of the application to the end users. The functionality provided for use by the end user largely is determined at development time by the developer. The selected functionality is exposed for use by the end user through a user interface also designed by the developer. Thus, the ease at which the end user accesses particular functionality of the application is mostly dictated by the arrangement of the user interface as determined by the developer at development time. Yet, it is to be recognized that different end users frequently different functionality of an application differently. Thus, at development time, it is difficult if not impossible for the developer to pre-arrange the user interface to provide ready access to a selection of the functionality of the application desired by all end users.

Recognizing the disparity of utilization of different application features, some applications permit the end user, manual customization of a primary user interface to provide rapid access to frequently accessed components. Oftentimes reflected in the form of a customizable tool bar or customizable home page, such applications permit the end user to select particular functions or modules of an application and to place a graphical control element at a desired location of a user interface screen so as to permit the end user ready access to the functionality most desired by the end user. However, allowing the end user to customize a user interface of the application presumes technical knowledge of the end user. Less technically sophisticated end users are unable to capitalize on the ability to customize the user interface. Further, to the extent that the frequency in which the end user accesses different functionality changes over time, the end user is required to periodically, manually change the user interface screen to meet the ever-changing needs of the end user.

### BRIEF SUMMARY OF THE INVENTION

Embodiments of the present invention address deficiencies of the art in respect to user interface customization and provide a novel and non-obvious method, system and computer program product for the adaptive customization of application components, such as different application modules or data objects. In an embodiment of the invention, an adaptive customization of application component method includes executing an application in memory of a computer and monitoring by the application interactions between an end user and the application. The method also includes computing by the application a frequency of access of components of the application. Finally, the method includes re-starting execution of the application including only components computed to be most frequently accessed while excluding components computed to be less frequently accessed.

In one aspect of the embodiment, the method additionally includes detecting end user access of a previously excluded one of the components and re-computing the frequency of access of the components, so that the re-computing causes the excluded one of the components to be considered most frequently accessed. Thereafter, execution of the application is restarted including only components computed to be most frequently accessed, including the previously excluded one of the components, while excluding components computed to be less frequently accessed. In another aspect of the embodiment, the method additionally includes detecting end user access of a previously excluded one of the components and re-computing the frequency of access of the components, so that the re-computing causes a previously includes one of the components to be considered less frequently accessed. Thereafter, execution of the application is restarted including only components computed to be most frequently accessed, while excluding components computed to be less frequently accessed including the previously included one of the components.

In another embodiment of the invention, a data processing system is configured for adaptive customization of application components. The system includes a computer with memory and at least one processor and an application executing in the memory of the computer. The application includes a multiplicity of application components. The system yet further includes an adaptive customization module of the application. The module includes program code enabled to monitor interactions between an end user and the application, to compute a frequency of access of components of the application and to re-start execution of the application including only components computed to be most frequently accessed while excluding components computed to be less frequently accessed.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for the adaptive customization of application components;

FIG. 2 is a schematic illustration of a data processing system configured for the adaptive customization of application components; and,

FIG. 3 is a flow chart illustrating a process for the adaptive customization of application components.

### DETAILED DESCRIPTION OF THE INVENTION

Embodiments of the invention provide for the adaptive customization of application components including program modules and data objects. In accordance with an embodiment, the interactions between an end user and an application are monitored, and a frequency of access of the components of the application are computed. Thereafter, on startup only the most frequently accessed components are included in the application during execution of the application in memory of a computer while less frequently access components of the application are excluded from execution. However, at the direction of the end user, one or more excluded ones of the components are loaded into memory for inclusion in the application and the loading of the excluded ones of the components included in the frequency computation so as to impact the selection of those components included in the application during a subsequent execution of the application. In this way, the selection of included components of the application adapts to the monitored utilization of the components by the end user.

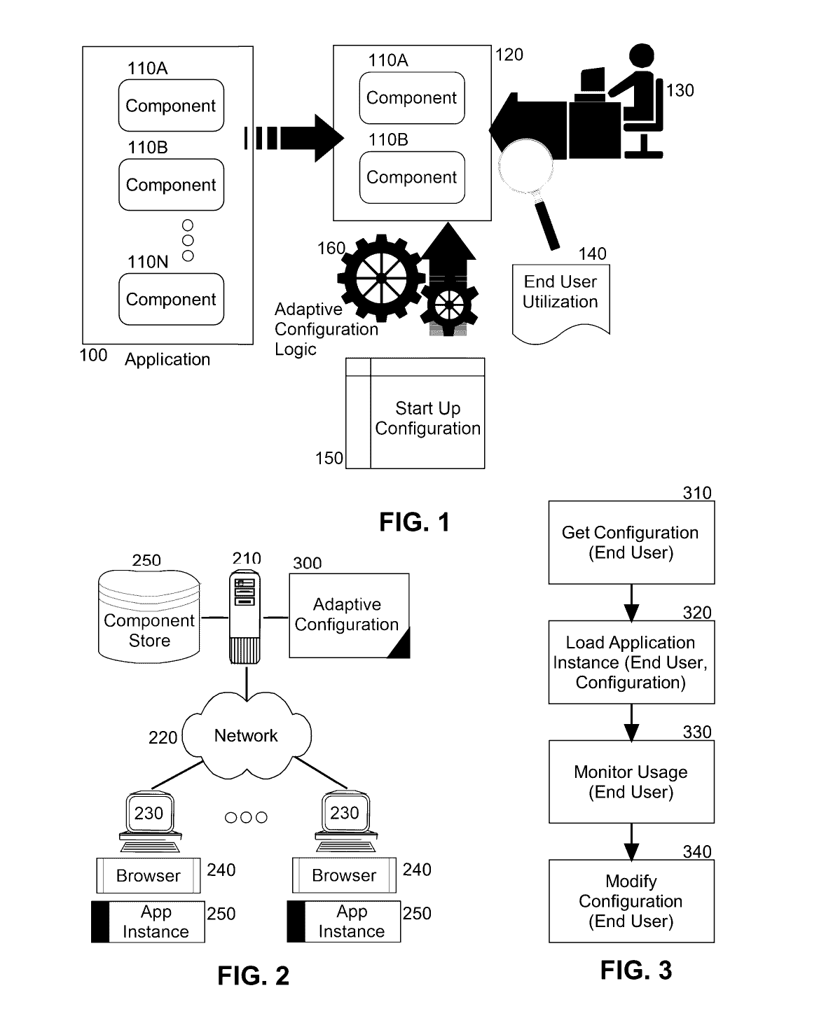

In further illustration, FIG. 1 pictorially shows a process for the adaptive customization of application components. As shown in FIG. 1, an application 100 of multiple different components 110A, 110B, 100N is defined in as much as the components include program modules and data objects used by the program modules to achieve the functionality of the application 100. At run-time, a startup configuration 150 is consulted by adaptive configuration logic 160 so as to determine which of the components 110A, 110B, 110N to include with an instance 120 of the application 110. Thereafter, the adaptive configuration logic 150 monitors access by an end user 130 of the different components 110A, 110B of the instance 120 of the application 110 in order to determine end user utilization data 140 of the components 120.

The end user utilization data 140 specifies the frequency of utilization of the different components 110A, 110B, 110N. Consequently, those of the different components 110A, 110B, 110N that are most frequently used by the end user 130 are identified as are those of the components 110A, 110B, 110N which are less frequently used by the end user 130. As such, in processing the end user utilization data 140, the adaptive configuration logic 160 then modifies the start-up configuration 150 to include the most frequently accessed ones of the components 110A, 110B, 110N while excluding from startup those of the components 110A, 110B, 110N that are least frequently used.

The process described in connection with FIG. 1 is implemented in a data processing system. In yet further illustration, FIG. 2 schematically shows a data processing system configured for the adaptive customization of application components. The system includes a host computing system 210 that includes one or more computers each with memory and at least one processor. Different client computers 230 are communicatively coupled to the host computing system 210 over computer communications network 220. Each of the client computers 230 supports the operation of a content browser 240 through which an application instance 250 of an application is presented.

In this regard, the application is a collection of components, each stored in component store 250. The components include both application modules and also data objects upon which the application modules operate. The application modules, for instance, may include different functions accessed by different user interface controls to retrieve data in the data objects, modify data in the data objects, create data in the data objects or delete data in the data objects. An adaptive configuration module 300 can execute in connection with the component store 250 so as to selected ones of the components to be included when providing each application instance 250 to different end users dependent upon a pre-specified configuration.

More particularly, the adaptive configuration module 300 includes program code that when executed in the host computing system 210, monitors the utilization of each of the application instances 250 so as to determine a frequency of utilization of each of the components present in each of the respective application instances 250. For each end user, a start-up configuration can be established including only those of the components determined to be most frequently used by a corresponding end user. Subsequently, the program code of the adaptive configuration module 300, in response to a request to start-up an application instance 250 for a corresponding end user, locates a start-up configuration for the end user and includes in the distribution of the application instance 250 to the end user only those components of the start-up configuration.

Of note, during utilization of an application instance 250 by an end user, the end user may manual direct the inclusion of one or more application components of the component store 250 not present in the application instance 250. In consequence, the program code of the adaptive configuration module 300 modifies the start-up configuration to recomputed the frequency of utilization of the components including those of the components manually directed for inclusion by the end user. Accordingly, during subsequent requests to provide the application instance 250, the composition of the components included in the application instance 250 will vary so as to have adapted to the utilization of the components by the end user.

In even yet further illustration of the operation of the adaptive configuration module 300, FIG. 3 is a flow chart illustrating a process for the adaptive customization of application components. Beginning in block 310, a start-up configuration is retrieved for an end user requesting from an application server the deployment of an application instance into the content browser of the end user. In block 320, components listed in the start-up configuration are included in the deployment of the application instance to the content browser of the end user. In block 330, the user interface interactions by the end user with the different components of the application instance are monitored including requests to include and utilize components not included at the time of deployment of the application instance to the end user. Based upon the monitored utilization, in block 340 the start-up configuration is modified to reflect the most frequently accessed components.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. An adaptive customization of application component method comprising:
executing an application in memory of a computer;
monitoring by the application interactions between an end user and the application;
computing by the application a frequency of access of components of the application; and,
re-starting execution of the application including only components computed to be most frequently accessed while excluding components computed to be less frequently accessed.

2. The method of claim 1, further comprising:
detecting end user access of a previously excluded one of the components;
re-computing the frequency of access of the components, the re-computing causing the excluded one of the components to be considered most frequently accessed; and,
re-starting execution of the application including only components computed to be most frequently accessed, including the previously excluded one of the components, while excluding components computed to be less frequently accessed.

3. The method of claim 1, further comprising:
detecting end user access of a previously excluded one of the components;
re-computing the frequency of access of the components, the re-computing causing a previously includes one of the components to be considered less frequently accessed; and,
re-starting execution of the application including only components computed to be most frequently accessed, while excluding components computed to be less frequently accessed including the previously included one of the components.

4. The method of claim 1, wherein the components comprise different application modules.

5. The method of claim 1, wherein the components comprise different data objects.

6. A data processing system configured for adaptive customization of application components, the system comprising:
a computer with memory and at least one processor;
an application executing in the memory of the computer, the application comprising a multiplicity of application components; and,
an adaptive customization module of the application, the module comprising program code enabled to monitor interactions between an end user and the application, to compute a frequency of access of components of the application and to re-start execution of the application including only components computed to be most frequently accessed while excluding components computed to be less frequently accessed.

7. The system of claim 6, wherein the program code is further enabled to detect end user access of a previously excluded one of the components, to re-compute the frequency of access of the components, the re-computing causing the excluded one of the components to be considered most frequently accessed, and to re-start execution of the application including only components computed to be most frequently accessed, including the previously excluded one of the components, while excluding components computed to be less frequently accessed.

8. The system of claim 6, wherein the program code is further enabled to detect end user access of a previously excluded one of the components, to re-compute the frequency of access of the components, the re-computing causing a previously includes one of the components to be considered less frequently accessed, and to re-start execution of the application including only components computed to be most frequently accessed, while excluding components computed to be less frequently accessed including the previously included one of the components.

9. The system of claim 6, wherein the components comprise different application modules.

10. The system of claim 6, wherein the components comprise different data objects.

11. A computer program product for the adaptive customization of application component, the computer program product comprising a computer readable storage medium having program instructions embodied therewith, the program instructions executable by a device to cause the device to perform a method comprising:
adaptive customization of application component method comprising:
executing an application in memory of a computer;
monitoring by the application interactions between an end user and the application;
computing by the application a frequency of access of components of the application; and,
re-starting execution of the application including only components computed to be most frequently accessed while excluding components computed to be less frequently accessed.

12. The computer program product of claim 11, wherein the method further comprises:
detecting end user access of a previously excluded one of the components;
re-computing the frequency of access of the components, the re-computing causing the excluded one of the components to be considered most frequently accessed; and,
re-starting execution of the application including only components computed to be most frequently accessed, including the previously excluded one of the components, while excluding components computed to be less frequently accessed.

13. The computer program product of claim 11, wherein the method further comprises:
detecting end user access of a previously excluded one of the components;
re-computing the frequency of access of the components, the re-computing causing a previously includes one of the components to be considered less frequently accessed; and,
re-starting execution of the application including only components computed to be most frequently accessed, while excluding components computed to be less frequently accessed including the previously included one of the components.

14. The computer program product of claim 11, wherein the components comprise different application modules.

15. The computer program product of claim 1, wherein the components comprise different data objects.
